(19) United States
(12) Patent Application Publication
(10) Pub. No.: US 2009/0044763 A1
(43) Pub. Date: Feb. 19, 2009

(54) WEARABLE APPARATUS FOR USING ONE OR MORE LEASHES IN A HANDS-FREE MANNER AND METHOD FOR USE

(75) Inventors: Nicole Russo, Teaneck, NJ (US); Ron Russo, Teaneck, NJ (US); Steven Cohen, New York, NY (US)

Correspondence Address: DORSEY & WHITNEY LLP;INTELLECTUAL PROPERTY DEPARTMENT, 250 PARK AVENUE, NEW YORK, NY, 10177, US

(73) Assignee: Steven Asher Cohen, Inc., New York, NY (US)

(21) Appl. No.: 12/191,629

(22) Filed: Aug. 14, 2008

Related U.S. Application Data
(60) Provisional application No. 60/965,008, filed on Aug. 16, 2007.

(51) Int. Cl. A01K 27/00; A62B 35/00

(52) U.S. Cl. 119/770; 119/857

(57) ABSTRACT

The present invention relates to a wearable apparatus for using one or more leashes in a hands-free manner and associated method for use. According to one exemplary embodiment of the present invention, a wearable apparatus for using at least one leash in a hands-free manner is provided. Such apparatus may have a first arrangement including a first strap having a first end and structured to extend at least to one shoulder of a person. A second arrangement may be provided that includes a second strap having a second end and a third end, with the second end being connected to the first end and the third end being directly or indirectly connectable to at least one leash, for example. A third arrangement may also be provided and coupled to the second arrangement and directly or indirectly connectable to at least one leash, for example.

### CROSS-REFERENCE TO RELATED APPLICATION(S)

The present invention claims priority from U.S. Patent Application Ser. No. 60/965,008 filed on Aug. 16, 2007, the entire disclosure of which is incorporated herein by reference.

### FIELD OF THE INVENTION

The present invention relates to a wearable apparatus which can include or attach thereto at least one leash or attachment used in a hands-free manner, and associated method for use. Particularly, the present invention relates to a wearable apparatus to which one or more leashes or attachments may be secured and used in a hands-free manner and an associated method that enables a user of the apparatus to secure to the apparatus and use one or more leashes or attachments in a hands-free manner.

### BACKGROUND INFORMATION

There are various types of leashes or attachments that may be used to keep a pet or a child secured to a person whenever a pet or a child needs to be restrained from leaving the proximity of said person by running or walking away, for example. Such variety of available leashes or attachments may vary in length, thickness and material from which they are manufactured. A typical and basic configuration of a leash or attachment is one that includes, e.g., a hook on one end that can be securely fastened to a pet's harness or collar. A loop is typically provided on the other end of such a leash that a person can use to hold on to the leash with one or more hands.

Another popular type of a leash or attachment provides an adjustable-length feature, which typically includes a spring loaded mechanism within a handheld unit. Such handheld unit allows the leash or attachment to be let out so as to increase the length between the end of the leash secured to a pet or child and the end held by a person. Such leash or attachment often has a feature that enables the user to prevent the leash from being let out at any point by depressing a button that engages and temporarily locks the wheel or cylinder within the handheld unit. Thus, the leash is wrapped around inside of the handheld unit when the leash is not fully extended.

Either type of leash described above (i.e., having a fixed-length or adjustable-length) is generally suitable for use with one pet or child and must be held by a person's hand when being used. This can pose a problem when a person who is using such leash desires or needs to have the use of both of their hands since one hand must hold on to the leash. Otherwise, the pet or child secured to the other end of the leash would be able to run or walk away dragging the leash behind themselves. Such situation can also be dangerous for the pet or child since the leash being dragged may still be secured to the pet's or child's harness or collar. This could thus cause injury to the pet or child if the loose handled end of the leash (e.g., loop) should get caught on something, such as a branch of a low bush, for example. In addition, a pet or child walking or running freely is susceptible to running in front of a moving vehicle and getting hit or run over, for example. There are numerous other potentially hazardous outcomes that could result from a pet or child walking or running freely as a result of a person accidentally dropping the leash, including, for example, wondering off and getting lost, hurting another person or pet, and damaging another person's property, for example.

The types of leases described above are often designed and used by a person with one pet, such as a dog, for example. When a person desires to walk more than one pet or child, it may become important for a person to use more than one leash (i.e., one leash per pet or child). Walking two pets, for example, could be accomplished by one person by using both of their hands (i.e., holding one leash in each hand). However, this renders a person from being able to use either of their hands for anything else that they may desire or need to do. As a result, a person may attempt to hold both leases with one hand. For a leash having a typical and basic configuration including a loop on the end of the leash held by a person, it may appear that holding two leashes is not a problem. However, holding two leashes in such a manner may create a situation where the two leashes become entangled with each other, and thus greatly limiting the range of movement of the each of the pets. In addition, a person attempting to hold two leashes with one hand may generally have less control over each pet or child secured to each leash, and may also be susceptible to dropping one or both leashes resulting from both pets pulling in the same or different directions. Such forces could also result in straining of a person's body, leading to soreness and injury.

A person who desires to hold more than two typical and basic leashes would likely have to hold at least two leashes in at least one of their hands, and thus certainly be susceptible to the drawbacks and potential hazards described above. A person who attempts to hold two or more adjustable leashes will likely face even greater difficulties and be even more susceptible to the drawbacks and potential hazards described above—this may be because such adjustable leashes typically include a hard plastic handle that is relatively large and somewhat bulky which can be very difficult to hold two with one hand and nearly impossible to hold more than two with one hand.

The problems and potential hazards described above may be associated with a person merely walking with one or more pets. However, these same problems and potential hazards are heightened when a person runs or jogs with one or more pets or children, and even more so, when a person attempts to do so while, e.g., rollerblading, skating, bicycling, skateboarding or pushing a baby stroller.

Accordingly, there is a need for an apparatus that addresses at least the problems described above by enabling a person to secure one or more leashes to their person and use such leashes in a hands-free manner so as to have full use of both of their hands.

### SUMMARY OF EXEMPLARY EMBODIMENTS

One of the objects of the present invention is to overcome the deficiencies commonly associated with the prior art a discussed above, and provide a wearable apparatus for using leashes or attachments in a substantially hands-free manner.

According to one exemplary embodiment of the present invention, a wearable apparatus for using at least one leash in a hands-free manner is provided. Such apparatus may have a first arrangement including a first strap having a first end and structured to extend at least to one shoulder of a person, for example. A second arrangement may be provided that includes a second strap having a second end and a third end, for example. The second end may be connected to the first end and the third end may be directly or indirectly connectable to at least one leash, for example.

The first arrangement or the second arrangement may include a back portion. The first strap may also have a fourth end that is directly or indirectly connectable to the back portion via a quick release connector, for example. The back portion may also include one or more strips that are structured to facilitate coupling a strap to the back portion. For example, the first strap and/or the second strap may be slideably coupled to the back portion. The first strap, second strap and/or back portion may include padding. The first strap or the second strap may also include a further portion, e.g. a length, and a strap adjuster that may adjust the further portion.

The first strap or the second strap may include a strip, a device and/or a portion that may be light reflectable, light emittable or sound emittable. The third end may be directly or indirectly connectable to at least one leash via a quick release connector. A third arrangement may also be provided that is connected or coupled to the second arrangement and directly or indirectly connectable to at least one leash, for example. At least one portion of the second arrangement may be is vertically provided between the first arrangement and the third arrangement. The third arrangement may include a ring to which at leash one leash may be directly or indirectly connectable.

According to another exemplary embodiment of the present invention, a wearable apparatus for using at least one leash in a hands-free manner is provided in which a first arrangement may include a first strap having a first end and be structured to extend at least to one shoulder of a person, for example. A second arrangement may be provided that is structured to be worn on a back or shoulder of a person, for example. The first arrangement may be directly or indirectly coupled to the second arrangement. A third arrangement also may be provided and be coupled to the second arrangement and directly or indirectly connectable to at least one leash, for example. At least one portion of the second arrangement may be vertically provided between the first arrangement and the third arrangement.

The second arrangement may include a second strap that has a second end and a third end that is connected to a first end of the first strap, for example. The third end may be directly or indirectly connectable to at least one leash via at least one quick release connector. The first strap or the second strap may includes a further portion and a strap adjuster, with the further portion being adjustable by the strap adjuster. The first strap may have a fourth end that may be directly or indirectly connectable via a quick release connector to a back portion included on the first arrangement, the second arrangement or the third arrangement, for example. The first arrangement, second arrangement and/or third arrangement may also include padding and a strip, device and/or portion that is light reflectable, light emittable and/or sound emittable. The apparatus according to an exemplary embodiment of the invention may further comprise a fourth arrangement that is directly or indirectly connectable to the at least one leash.

Another object of the present invention is to provide a method for using a wearable apparatus for using at least one leash in a hands-free manner. According to an exemplary embodiment of the present invention, such a method is provided that may include providing a first arrangement including a first strap having a first end and structured to extend at least to one shoulder of a person, for example. The exemplary method may also include providing a second arrangement including a second strap having a second end and a third end. The a second end may be connected to the first end, and the third end may be directly or indirectly connectable to at least one leash, for example.

According to another exemplary embodiment of the present invention, a method is provided that may include providing a first arrangement that includes a first strap having a first end and structured to extend at least to one shoulder of a person. The exemplary method may also include providing a second arrangement that is structured to be worn on a back or shoulder of a person, for example. The first arrangement may be directly or indirectly coupled to the second arrangement. The exemplary method may also include providing a third arrangement coupled to the second arrangement and either directly or indirectly connectable to at least one leash, for example. At least a portion of the second arrangement may be vertically provided between the first arrangement and the third arrangement.

These and other objects, features and advantages of the present invention will become apparent upon reading the following detailed description of exemplary embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying Figures showing illustrative embodiments of the invention, in which:

FIG. 1 is a front view of an exemplary embodiment of a wearable apparatus according to the present invention for using at least one leash or attachment in a substantially hands-free manner, configured for use with two pets;

FIG. 2 is a rear view of the exemplary embodiment of the apparatus shown in FIG. 1;

FIG. 3 is a front view of the exemplary embodiment of the apparatus shown in FIGS. 1 and 2, shown as worn by a user and used with two dogs;

FIG. 4 is a rear view of the exemplary embodiment of the apparatus shown in FIGS. 1-3, shown as worn by a user and used with two dogs;

FIG. 5 is a front view of another exemplary embodiment of a wearable apparatus according to the present invention for using at least one leash or attachment in a substantially hands-free manner;

FIG. 6 is of an arrangement according to another exemplary embodiment of an apparatus according to the present invention that provides for use thereof with more than two pets, children, etc.; and

FIG. 7 is of an arrangement according to a further exemplary embodiment of the apparatus according to the present invention that provides for use thereof with only one pet, child, etc.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described exemplary embodiments without departing from the true scope and spirit of the subject invention as defined by the appended claims.

### DETAILED DESCRIPTION OF EXEMPLARY EMBODIMENTS

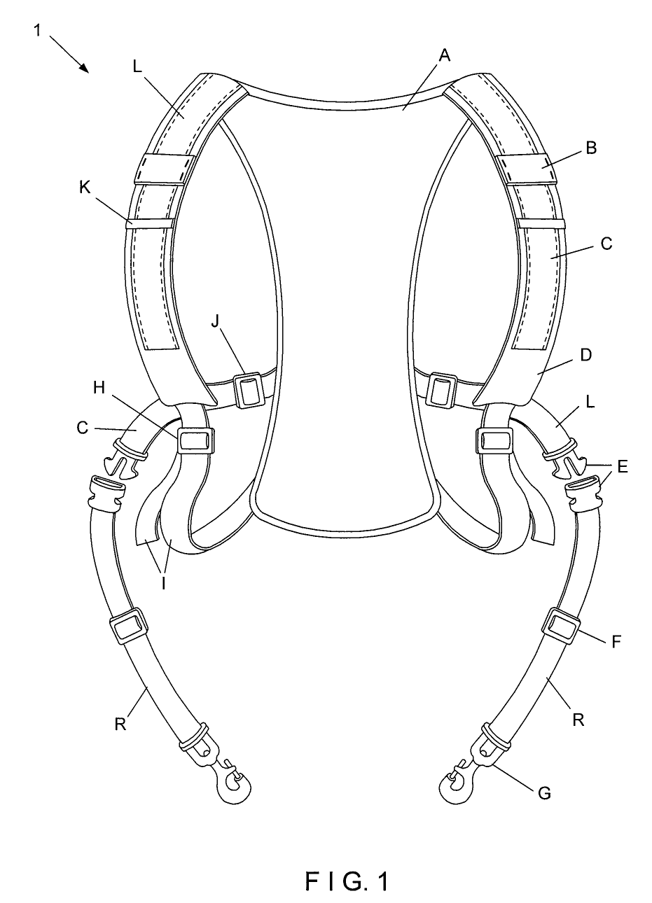

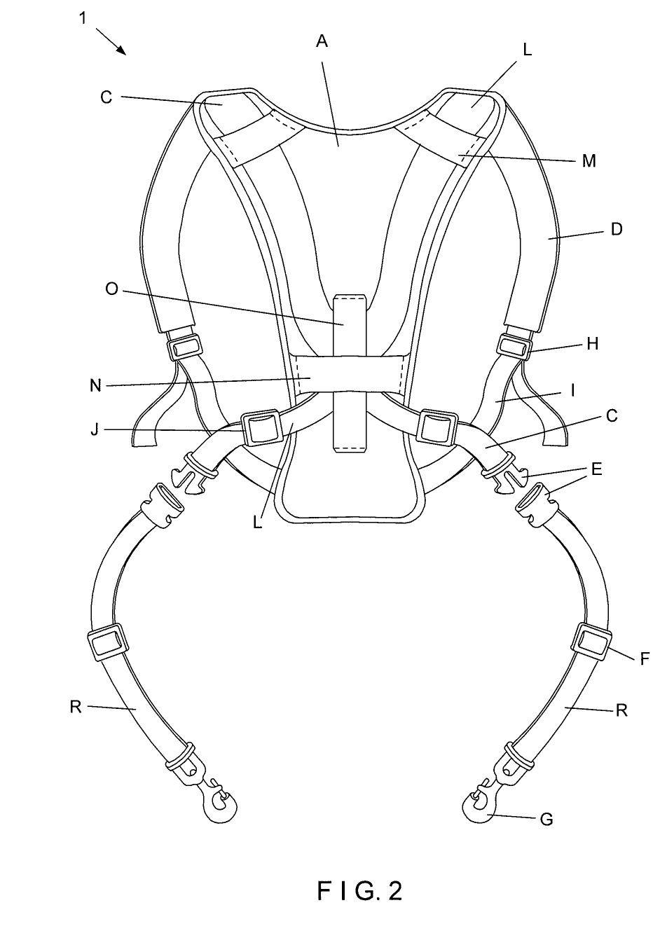

FIG. 1 shows a front view of an exemplary embodiment of a wearable apparatus according to the present invention for using at least one leash or attachment in a substantially hands-free manner, e.g., configured for use with two pets, children, etc. Apparatus 1 comprises two straps D, each one being structured to go over and in front of one of each of the use's two shoulders when wearing the apparatus. Strap D may be padded to provide for a greater comfort to the user's shoulders and chest when the apparatus 1 is worn and used by the user. Attached to one of the straps D on one side of apparatus 1 at approximately the upper most portion of apparatus 1 is strap C, which traverses across the rear of apparatus 1, as shown in FIG. 2. Similarly, attached to the other one of the straps D on the other side of apparatus 1 at approximately the upper most portion of apparatus 1 is strap L, which traverses across the rear of apparatus 1, as shown in FIG. 2. For illustrative purposes, strap C is shown in the exemplary embodiment illustrated in FIGS. 1-4 as traversing from the upper left-hand side to the lower right-hand side as from the perspective of a user when wearing apparatus 1, while strap L is shown in the exemplary embodiment illustrated in FIGS. 1-4 as traversing from the upper right-hand side to the lower left-hand side as from the perspective of a user when wearing apparatus 1.

As can also be seen in FIG. 1, strap B is attached to each of the two straps D (on the front of apparatus 1), which, according to the exemplary embodiment shown in FIG. 1, may be made or covered with, e.g., a highly light-reflective material. In addition to strips B, other safety orientated features may be incorporated into or on apparatus 1 for purposes of, e.g., reflecting light from a car or other vehicle. Further, one or more strips B and/or alternate safety orientated features may be attached at multiple locations on apparatus 1 other than is shown in the exemplary embodiment illustrated in FIGS. 1-4. Such other exemplary safety features may include, for example, a flashlight, a flashing light, some other light emitting device or a whistle, for example. As further shown in the exemplary embodiment of an apparatus according to the present invention illustrated in FIG. 1, loop K can be attached to strap D for added strength and support and/or for the user to hold onto when desired (e.g., when donning and/or adjusting apparatus 1).

Further, as shown in the exemplary embodiment illustrated in FIG. 1, strap I is attached to strap D, on the distal end of strap D from strap C or L, as the case may be. As can be seen in FIG. 1, for example, there may be two straps I, one corresponding to each strap D. Each strap I can be further attached, on its distal end from where it is attached to strap D, to the lower portion of back support A. This exemplary configuration effectively forms two loops, comprising back support A and straps I, D and C, and back support A and straps I, D and L, respectively, which provide for apparatus 1 to be worn over the shoulders of a user. Each strap I can comprise a slide strap adjuster H that may be used to adjust the length of strap I, thereby providing each of the loops comprising back support A and straps I, D and C, and back support A and straps I, D and L, respectively, to be adjusted by the user to provide a secure and comfortable fit based on the size of the user. Straps I may also be used, for example, to assist a user by making it easier to take off apparatus 1 in addition to donning and adjusting the fit of apparatus 1.

As shown in the exemplary embodiment of the apparatus according to the present invention illustrated in FIG. 2, back support A can comprise two strips M, which may each be attached to back support A at approximately the portions of back support A that rest near each of the user's upper back and shoulders. Each strip M is shown as being attached to back support A by each of the two ends of each strip M so as to form a loop through which one of each of the straps C and L may traverse. Thus, support of back support A and its being held in position with respect to the user's body when worn is facilitated. As can also be seen in FIG. 2, strips N and O are each also attached to back support A at approximately the portion of back support A corresponding to the user's lower-middle back. Each end of each of the strips N and O is attached to back support A to form two loops that cross over each other in an approximately perpendicular manner. Straps C and L each traverse through the double crossover loop formed by strips N and O, thereby further assisting with the support of back support A and its being held in position with respect to the user's body when worn, as well as to help distribute the pressure from straps C and L when under tension during use. Each of straps C and L further has attached thereto a slide strap adjuster J that can be used to individually adjust the lengths of straps C and L by a user for proper fit and comfort based on the size of the user.

As further shown in the exemplary embodiment of the present invention illustrated in FIG. 2, for example, buckle E is attached to the distal end of each of straps C and L from where straps C and L attach to straps D at approximately the top of apparatus 1. Buckle E is also attached to each one of leashes R, thereby providing for a releasable connection of one of leashes R to strap C and another of leashes R to strap L, as also illustrated in FIG. 2.

Buckle E may preferably be, for example, a quick release buckle that comprises two releasably locking portions that enables a user to quickly and easily release one of the leashes R from straps C or L (as the case may be), and thus from the rest of apparatus 1 as worn by a user. Buckle E may preferably be made of a light and strong plastic material, for example. However, other materials, such as carbon fiber or a metal alloy, e.g., may also be used if desired for added strength and/or appearance. Each of the leashes R may further comprise one or more slide strap adjusters F, for example, which can be used to individually adjust the length of leash(es) R based on the height of the user and the size of the pet or child to be secured to the apparatus thereby.

As shown in FIG. 2, a swivel eye snap hook G is attached to the distal end of each of the leashes R from where each of the leashes R connect to the rest of apparatus 1 via one of the buckles E. Such exemplary hook G may be connected directly to a pet's or child's harness or collar. Swivel eye snap hook G may preferably be used as its swivel functionality may help prevent a leash R from being twisted during use, and thus help to reduce the stresses that may be felt by a user and/or a pet or child that may occur as a result of leash R being twisted during use. According to the exemplary embodiment shown in FIG. 2, swivel eye snap hook G can be made of metal. However, alternate forms of hooks or connectors may be used in place of swivel eye hook G, as well as the material from which such hook is made (e.g., a plastic swivel eye hook or a metal spring hook may also be used).

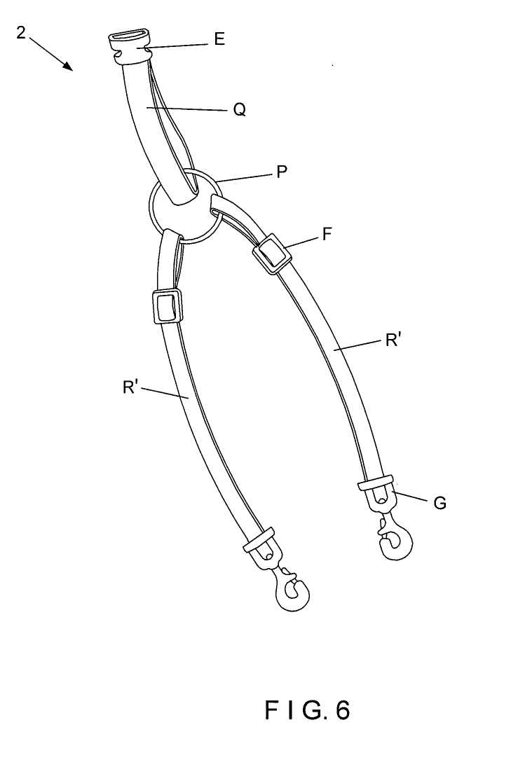

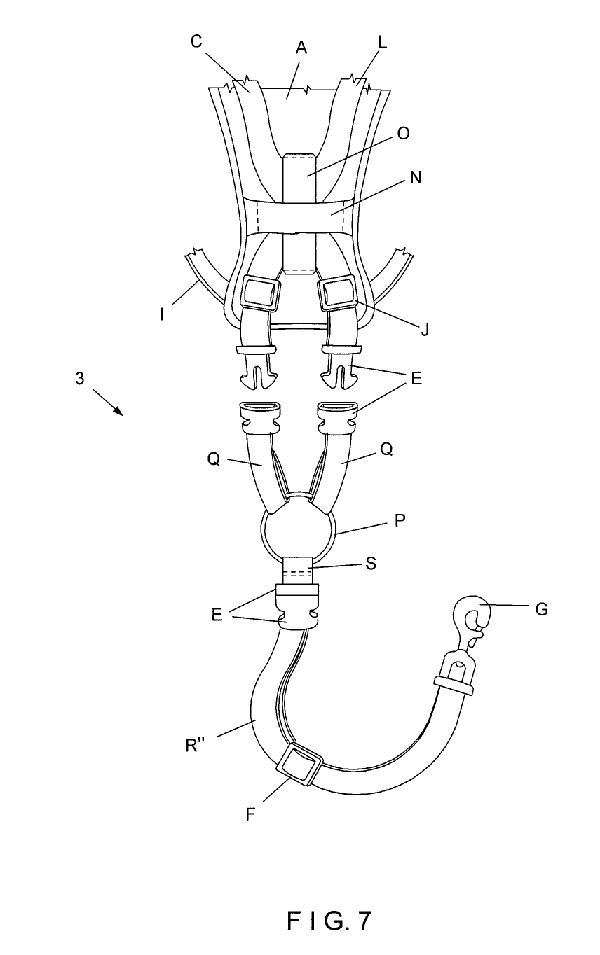

As shown in the exemplary embodiment of the present invention illustrated in FIG. 2, there can be two leashes R. Other exemplary embodiments provide for three or more leashes or only one leash, as described below. The exemplary embodiment illustrated in FIG. 2 may utilize one or more buckles E, and the arrangements shown in FIGS. 6 and 7 illustrate the use of the exemplary apparatus for a number of pets or children, including one, two, three or four, for example. More pets or children can be accommodated by the exemplary apparatus according to the present invention either by using multiple arrangements of the arrangement shown in FIG. 6 in series and/or parallel, and/or by using any other similar suitable device.

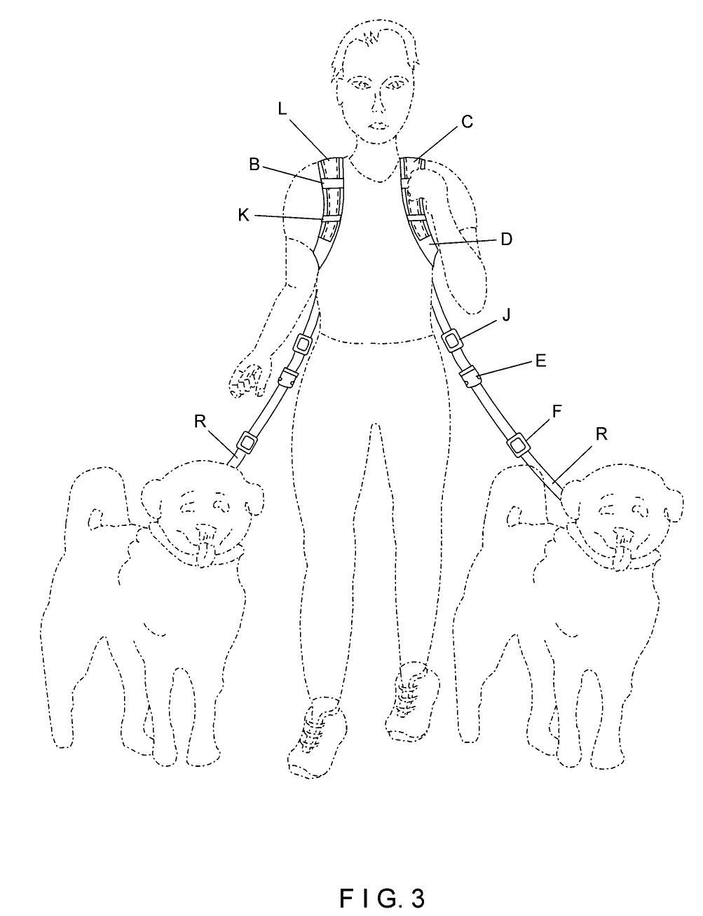

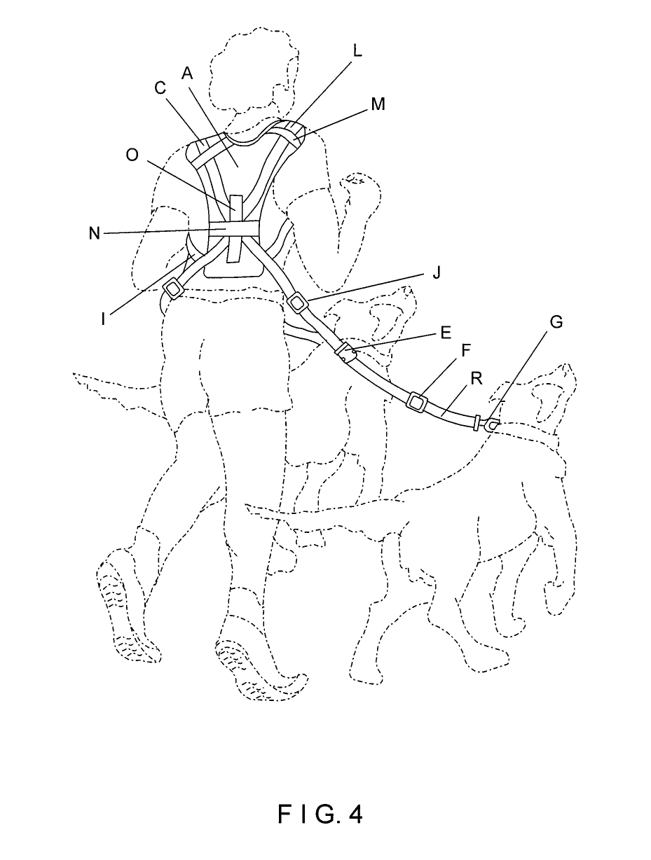

FIGS. 3 and 4 illustrate the exemplary embodiment of the apparatus according to the present invention shown in FIGS. 1 and 2 while the apparatus is in use. For example, FIG. 3 shows a front view of the exemplary apparatus of FIGS. 1 and 2 in use by a person walking two dogs, for example. FIG. 4 shows a rear view of the exemplary apparatus in FIGS. 1 and 2 being used by a person walking two dogs, for example. As can be seen in the exemplary embodiment of FIGS. 3 and 4, there is one leash R for each pet being walked. According to the exemplary embodiment shown in FIGS. 3 and 4, each pet being walked can be a dog (of course, other animals or humans can be attached using leash R). Each leash R attaches to the collar of each dog, respectively, via a swivel eye hook G attached to one end of each leash R. The other end of each leash R is attached to a corresponding buckle E, which is in turn attached to straps C or L (as the case may be), for example.

As is shown in the exemplary embodiment of the present invention illustrated in FIG. 4, each leash R extends from one of straps C and L via buckle E. Straps C and L traverse the user's back, and are partly secured to back support A by the double crossover loop formed by strips N and O. Straps C and L are further secured to back support A by strips M before looping over the user's shoulder, approximately where straps C and L connect to one of portions of straps D, respectively. This exemplary configuration can distribute the tension and other forces when in use (e.g., when a dog pulls on a leash R) over the user's back, shoulders and chest, for example, may provide for greater comfort and stability to the user. Slide strap adjusters F and J provide for adjusting the length of strap-leash combination C-R or L-R (as the case may be), which can further assist in providing greater comfort and stability to the user when using the exemplary apparatus.

As can be seen in FIGS. 3 and 4, the user (wearer) of the exemplary embodiment of the apparatus illustrated in these figures, is able to securely walk, e.g., multiple pets without using his/her hands or arms. This is because, as can be ascertained in the drawings, when the exemplary apparatus is worn and properly fitted via strap adjusters H, the apparatus securely rests on the shoulders, back and chest of the user. Further comfort and balance may be achieved by adjusting slide strap adjusters J and F, which may be particularly beneficial when using this exemplary apparatus to walk multiple pets that are not of the same size, for example. Slide strap adjusters may also be used to provide for varying lengths of strap-leash combinations C-R and L-R if it is desired to vary the lengths so that one pet may walk further ahead or have greater range of motion than another, whether or not the pets are of the same size. As one skilled in the art would ascertain, such functionality may be desirous, for example, when one pet frequently attempts to play or distract another pet and the user wants to enable the other pet to be able to stay out of reach from the one pet attempting to play or distract it. Another example when such functionality may be desirous is when one pet poses a potential threat to another person or child while another pet does not, and the user wants to enable the other pet to be able to play with the other person or child while keeping the potentially dangerous pet from being able to reach and thus potentially cause harm to the other person or child.

As one skilled in the art can further ascertain, although an exemplary embodiment of the present invention is shown in FIGS. 3 and 4 with a user who is walking or jogging, the exemplary apparatus according to the present invention may also be used by a person that is roller blading, roller skating, skateboarding, riding a bicycle, pushing a baby stroller, carrying parcels or using a cell phone, for example. Although such activities may be potentially dangerous when performing such while “walking” a pet, such danger may be reduced when using the exemplary apparatus according to the present invention as it enables the user to use both of their hands when, for example, riding a bicycle or pushing a baby stroller, and therefore have better control of the bicycle or baby stroller, for example, than attempting to ride a bicycle or push a baby stroller with one hand, and holding on to one or more leashes with the other.

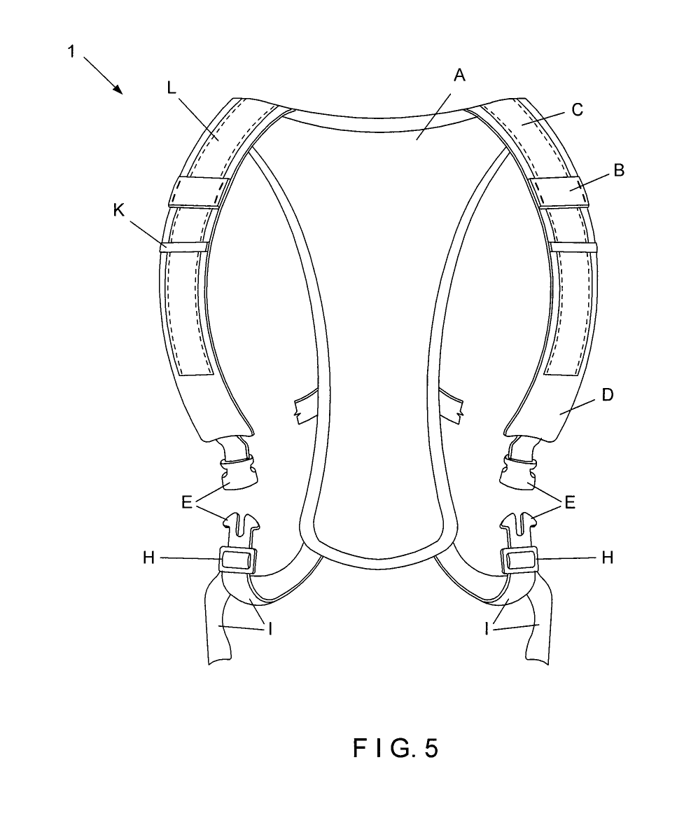

FIG. 5 shows a front view of an apparatus according to another exemplary embodiment of the present invention. As one skilled in the art can ascertain, the exemplary embodiment shown in FIG. 5 is similar to that shown in FIG. 1. However, a buckle E has been added to each strap I, where buckle E is preferably a quick release buckle. As shown in FIG. 5, for example, buckles E on straps I can be the same as buckles E used to connect leashes R to straps C and L. However, one skilled in the art can ascertain that buckles E on straps I may be different than buckles E used to connect leashes R to straps C and L. Buckles E on straps I may be advantageous when the user desires or needs to quickly take off apparatus 1 and it is not desired or possible for the user to slide their arm out from under one or both of shoulder straps D. Buckles E on straps I may also be desirable if the user prefers to use buckles E on straps I to put-on or take-off apparatus 1 with each use without having to make any adjustments via slide strap adjusters H, for example.

FIG. 6 shows an arrangement 2 according to another exemplary embodiment of an apparatus according to the present invention that provides for use with more than two pets or children. The exemplary arrangement 2 shown in FIG. 6 may be attached to one of buckles E in place of one of leashes R to increase the number of pets or children that may be securely attached to the exemplary apparatus shown in FIGS. 1 and 2, for example. As shown in FIGS. 1 and 2, for example, each buckle E provides for the attachment of one of the leashes R to the rest of apparatus 1, thereby providing for walking two pets in a hands-free manner, for example. When one of the leashes R from the exemplary embodiment shown in FIGS. 1 and 2 can be replaced with the exemplary arrangement 2 shown in FIG. 6, three pets may be securely attached to the rest of the apparatus for walking in a hands-free manner, for example. When both of the leashes R from the exemplary embodiment shown in FIGS. 1 and 2 are replaced with an exemplary arrangement 2 shown in FIG. 6, four pets may be securely attached to the rest of the apparatus for walking in a hands-free manner, for example.

As shown in the exemplary embodiment illustrated in FIG. 6, for example, arrangement 2 includes part of buckle E at one end, which attaches to the corresponding part of one of the buckles E attached to straps C or L. Arrangement 2 further includes cord Q that connects buckle E to ring P by being attached to buckle E on one end and to ring P on the other end. Further attached to ring P are two leashes R′. At the distal end of each R′ from where each R′ attaches to ring P, is a swivel eye snap hook G, which can be releasably attached to a collar or harness of a pet or child to be secured to apparatus 1 for being walked by a user in a hands-free manner, for example. A slide strap adjuster F can be provided on each leash R′ that can be used to vary the length of each leash R′ independently from one another. Adjusting the length of each leash R′ may be desirous for similar reasons discussed above with respect to adjusting the length of one or more of leashes R, for example (e.g., size of pet, potential distraction of one pet by another, potential danger to another person or child, etc.).

When two of arrangements 2 as shown in FIG. 6 are employed, for example, that are attached to each one of buckles E on the ends of straps C and L, respectively, one skilled in the art can ascertain that a total of four pets or children may be secured to apparatus 1 and be walked by a user in a hands-free manner. One skilled in the art will further ascertain that additional leashes R′ may also be attached to ring P, providing for more than two pets or children to be securely attached to apparatus 1 via each arrangement 2. Thus, for example, if each arrangement 2 has three leashes R′ connected to ring P and there are two arrangements 2 attached via each of the buckles E on the ends of straps C and L to apparatus 1, a total of six pets or children can be securely attached to apparatus 1 and walked by the user in a hands-free manner. If, for example, each arrangement 2 has four leashes R′ attached thereto, then eight pets or children can be simultaneously walked in a hands free manner, and so on.

Further, for example, one skilled in the art can ascertain that one or each of swivel eye snap hooks G may be replaced with another ring P or other manner for attaching more than one leash and so multiple arrangements similar to that showed in FIG. 6 can be connected in series. Such a configuration can facilitate more than two pets or children to be secured to each such arrangement without having multiple leashes R′, all stemming from the same ring, and thereby reduce the potential for multiple leashes R′ to become entangled with one another, for example. Such configurations may also provide leashes R′ to further vary in length from their adjustability as enabled by slide strap adjusters F, for example.

FIG. 7 shows an arrangement according to a further exemplary embodiment of the apparatus according to the present invention that can be used with, e.g., one pet or child with respect to balanced tension and comfort to the user. Similarly to the exemplary arrangement 2 discussed above, arrangement 3 also has a ring P. However, instead of only one buckle E attached to ring P via cord Q, exemplary arrangement 3 has two buckles E, with each buckle E being attached to ring P via a separate cord Q. Additionally, one leash R″ is attached to ring P. As shown in FIG. 7, leash R″ is attached to ring P via another buckle E and strap S. However, as one skilled in the art can ascertain, leash R″ may be attached directly to ring P similarly to how leashes R′ are each attached to ring P in the exemplary embodiment of arrangement 2 illustrated in FIG. 6, for example.

FIG. 7 further shows that slide strap adjuster F is also connected to leash R″ and can be used to vary the length of leash R″, and swivel eye snap hook G that can be attached directly to a pet's or child's harness or collar, as in the case of the exemplary embodiments discussed herein. The exemplary arrangement illustrated in FIG. 7 can be used when, e.g. only one pet or child is to be secured to apparatus 1 for walking by a user in a hands-free manner. It can be well suited for use with the exemplary embodiments of the present invention illustrated in FIGS. 1-5 so that the tension forces from a pet or child pulling on leash R″, for example, may be more evenly distributed than if, e.g. one pet was attached to a single leash R that in turn was only attached to one of straps C and L shown in FIGS. 1-5, for example.

As one skilled in the art can ascertain, using an apparatus according to an exemplary embodiment of the present invention can provide greater comfort, balance and distribution of tension and other forces acting on the user, for example, than when a pet or child is walked without using such exemplary apparatus. This in turn can provide a greater sense of unity between the user and the pet(s) or child(ren) secured to the user via leash(es) R, thereby providing for greater control over the pet(s) or child(ren) by the user, than when a pet or child is walked without using such exemplary apparatus. The multiple adjustments heretofore described within various exemplary embodiments of an apparatus according to the present invention can provide the user with the ability to optimally fit such apparatus to their person, while accounting for varying heights of users, pets and children.

One skilled in the art will further appreciate that padding may be added to back support A and/or shoulder straps D, for example, to provide even greater comfort to the user and further relieve pressure on the user from the apparatus, particularly as applied to a user's back, shoulders and chest, for example. Although any suitable materials may be used, exemplary embodiments of the present invention may utilize, for example, nylon for the straps, leashes, cords and back support, plastic for the buckles and slide strap adjusters, high density foam for padding, and metal for ring(s) and swivel eye snap hook(s). Various components may be attached to one another via stitching using nylon or monochord thread, for example, or via any other suitable attachment manner. As described above, a highly light-reflective material or light-emitting device may be used for strip(s) B or any other suitable safety features attached to or incorporated within various exemplary embodiments of the present invention, for example.

The foregoing merely illustrates the principles of the invention. Various modifications and alterations to the described exemplary embodiments will be apparent to those skilled in the art in view of the teachings herein. It will thus be appreciated that those skilled in the art will be able to devise numerous devices, arrangements and methods which, although not explicitly shown or described herein, embody the principles of the invention and are thus within the spirit and scope of the present invention. The detailed description, given by way of example, but not intended to limit the invention solely to the specific exemplary embodiments described, may best be understood in conjunction with the accompanying Figures.

What is claimed is:

1. A wearable apparatus for using at least one leash in a hands-free manner, comprising:
a first arrangement including at least one first strap having at least one first end, the at least one first strap structured to extend at least to one shoulder of a person; and
a second arrangement including at least one second strap having at least one second end and at least one third end, wherein the at least one second end is connected to the at least one first end, and wherein the at least one third end is at least one of directly or indirectly connectable to the at least one leash.

2. The wearable apparatus recited in claim 1, wherein at least one of the first arrangement or the second arrangement includes a back portion.

3. The wearable apparatus recited in claim 2, wherein the at least one first strap has at least one fourth end, and wherein the at least one fourth end is at least one of directly or indirectly connectable to the back portion.

4. The wearable apparatus recited in claim 3, wherein the at least one fourth end is at least one of directly or indirectly connectable to the back portion via at least one quick release connector.

5. The wearable apparatus recited in claim 2, wherein the back portion includes at least one strip structured to facilitate coupling of at least one strap to the back portion, and wherein at least one of the at least one first strap or the at least one second strap is slideably coupled to the back portion.

6. The wearable apparatus recited in claim 2, wherein at least one of the at least one first strap, the at least one second strap or the back portion includes a padding.

7. The wearable apparatus recited in claim 1, wherein at least one of the at least one first strap or the at least one second strap includes a further portion and at least one strap adjuster, wherein the further portion is adjustable by the at least one strap adjuster.

8. The wearable apparatus recited in claim 1, wherein one of the at least one first strap or the at least one second strap includes at least one of at least one strip, at least one device or at least one portion, and wherein the at least one of the at least one strip, the at least one device or the at least one portion is at least one of light reflectable, light emittable or sound emittable.

9. The wearable apparatus recited in claim 1, wherein the at least one third end is at least one of directly or indirectly connectable to the at least one leash via a quick release connector.

10. The wearable apparatus recited in claim 1, further comprising a third arrangement, wherein the third arrangement is at least one of connected or coupled to the second arrangement and at least one of directly or indirectly connectable to the at least one leash, wherein at least one portion of the second arrangement is vertically provided between the first arrangement and the third arrangement.

11. The wearable apparatus recited in claim 10, wherein the third arrangement includes a ring to which the at leash one leash is at least one of directly or indirectly connectable.

12. A wearable apparatus for using at least one leash in a hands-free manner, comprising:
a first arrangement including at least one first strap having at least one first end, the at least one first strap structured to extend at least to one shoulder of a person;
a second arrangement structured to be worn on at least one of a back or the at least one shoulder, wherein the first arrangement is at least one of directly or indirectly coupled to the second arrangement; and
a third arrangement coupled to the second arrangement and at least one of directly or indirectly connectable to the at least one leash, wherein at least one portion of the second arrangement is vertically provided between the first arrangement and the third arrangement.

13. The wearable apparatus recited in claim 12, wherein the second arrangement includes at least one second strap having at least one second end and at least one third end, wherein the at least one first strap has at least one first end, wherein the at least one second end is connected to the at least one first end, and wherein the at least one third end is at least one of directly or indirectly connectable to the at least one leash.

14. The wearable apparatus recited in claim 13, wherein the at least one third end is at least one of directly or indirectly connectable to the at least one leash via at least one quick release connector.

15. The wearable apparatus recited in claim 13, wherein at least one of the at least one first strap or the at least one second strap includes a further portion and at least one strap adjuster, and wherein the further portion is adjustable by the at least one strap adjuster.

16. The wearable apparatus recited in claim 13, wherein the at least one first strap has at least one fourth end, and at least one of the first arrangement, the second arrangement or the third arrangement includes a back portion, and wherein the at least one fourth end is at least one of directly or indirectly connectable to the back portion.

17. The wearable apparatus recited in claim 16, wherein the at least one fourth end is at least one of directly or indirectly connectable to the back portion via at least one quick release connector.

18. The wearable apparatus recited in claim 12, wherein at least one of the first arrangement, the second arrangement or the third arrangement includes at least one of a padding and at least one of at least one strip, at least one device or at least one portion, and wherein the at least one of the at least one strip, the at least one device or the at least one portion is at least one of light reflectable, light emittable or sound emittable.

19. The wearable apparatus recited in claim 12, further comprising a fourth arrangement, wherein the fourth arrangement is at least one of directly or indirectly connectable to the at least one leash.

20. A method for using a wearable apparatus for using at least one leash in a hands-free manner, comprising:
providing a first arrangement including at least one first strap having at least one first end, the at least one first strap structured to extend at least to one shoulder of a person; and
providing a second arrangement including at least one second strap having at least one second end and at least one third end, wherein the at least one second end is connected to the at least one first end, and wherein the at least one third end is at least one of directly or indirectly connectable to the at least one leash.

21. A method for using a wearable apparatus for using at least one leash in a hands-free manner, comprising:
providing a first arrangement including at least one first strap having at least one first end, the at least one first strap structured to extend at least to one shoulder of a person;
providing a second arrangement structured to be worn on at least one of a back or the at least one shoulder, wherein the first arrangement is at least one of directly or indirectly coupled to the second arrangement; and
providing a third arrangement coupled to the second arrangement and at least one of directly or indirectly connectable to the at least one leash, wherein at least one portion of the second arrangement is vertically provided between the first arrangement and the third arrangement.
